(19) United States
(12) Patent Application Publication
(10) Pub. No.: US 2013/0119768 A1
(43) Pub. Date: May 16, 2013

(54) POWER SUPPLY HAVING REDUNDANT POWER

(71) Applicant: ZIPPY TECHNOLOGY CORP., New Taipei City (TW)

(72) Inventor: Yu-Yuan CHANG, New Taipei City (TW)

(73) Assignee: ZIPPY TECHNOLOGY CORP., New Taipei City (TW)

(21) Appl. No.: 13/713,434

(22) Filed: Dec. 13, 2012

Related U.S. Application Data
(63) Continuation-in-part of application No. 11/896,729, filed on Sep. 5, 2007.

(51) Int. Cl. H02J 7/34

(52) U.S. Cl. CPC H02J 7/34
USPC 307/66

(57) ABSTRACT

A power supply system providing backup power comprises at least one power supply, at least one power storage unit and a power integration panel. The power supply converts an input power into a conversion power and sends at the same time a power good signal to a motherboard. The power storage unit receives the conversion power in normal conditions and saves electric energy to generate a backup power. The power integration panel includes a power control unit connected to the power supply to determine whether the conversion power is output through the power good signal, a backup control unit connected to the power storage unit to compare the conversion power and backup power to determine whether the backup power is output, and a power regulation unit connected to the power control unit and backup control unit to regulate the conversion power or backup power to be an output power.

This application is a continuation-in-part, and claims priority, of from U.S. patent application Ser. No. 11/896,729 filed on Sep. 05, 2007, entitled “POWER SUPPLY HAVING REDUNDANT POWER”, the entire contents of which are hereby incorporated by reference.

### FIELD OF THE INVENTION

The present invention relates to a power supply system providing backup power and particularly to a power supply system that determines whether a backup power is output through a power good signal and voltage.

### BACKGROUND OF THE INVENTION

During operation of computer equipment, in the event that power supply is unstable, system abnormal shutdown or data damage could easily occur, or even casing thereof could be damaged. All these cause significant loss. To prevent the aforesaid problems from taking place, modern computer equipment mostly has a redundant power supply system consisting of a plurality of power supplies. The redundant power supply system mainly comprises two or more power supplies and a power integration panel. Every power supply receives the same input power and converts the input power to output a conversion power to the power integration panel. The power integration panel regulates the conversion power to become an output power to supply and drive at least one load for operation. In the event that one of the power supplies malfunctions and outputs abnormally, the power integration panel transfers the power allocated to the malfunctioned power supply to other normal power supplies for sharing, thereby the malfunctioned power supply can be isolated immediately and replaced by other normal power supplies. During the transfer process, as the power integration panel provides a hot plug function, the redundant power supply system does not need to be shut down entirely to transfer to another normal power supply.

In addition to the redundant power supply system as previously discussed, there is another Uninterruptible Power Supply (UPS) system to resolve the problem of unstable power. The UPS system saves power in normal conditions and provides emergent power for the computer equipment, such that the computer equipment can have a buffer time to perform normal data storage and shutdown. The UPS system mainly comprises a power supply and a power storage unit. When the power supply converts the power, the power storage unit is charged regularly. In the event that the power supply cannot supply power normally, the UPS system immediately supplies power through the power storage unit. However, during operation of the UPS system, if either the power supply or power storage unit malfunctions, the malfunctioned power supply (or power storage unit) cannot be replaced immediately, the entire system has to be shut down to facilitate the downstream repair and maintenance.

While the redundant power supply system can solve the problem of maintenance difficulty in the UPS system through the power integration panel, every power supply of the redundant power supply system is connected to the same power input source (such as commercial power). In the event that the power input source cannot supply power normally, every power supply also cannot supply power, so that the computer equipment cannot get driving power and have to be shut down.

### SUMMARY OF THE INVENTION

The primary object of the present invention is to overcome the problem of conventional redundant power supply system that is unable to operate normally when external input power is not supplied normally.

To achieve the foregoing object, the present invention provides a power supply system providing backup power. The power supply system is electrically connected to an external power input source and converts an input power into an output power, and sends the output power through a power output terminal to drive a motherboard. The power supply system comprises at least one power supply, at least one power storage unit and a power integration panel. The power supply is connected to the external power input source to receive the input power and convert the input power into a conversion power, and send at the same time a power good signal to the motherboard. The power storage unit receives the conversion power in normal conditions and saves electric energy to generate a backup power. The power integration panel includes a power control unit connected to the power supply to determine whether the conversion power is output or not through the power good signal, a backup control unit connected to the power storage unit to compare the conversion power and backup power to determine whether the backup power is output or not, and a power regulation unit connected to the power control unit and backup control unit to regulate the conversion power or backup power to be the output power sent to the power output terminal.

In one embodiment the power supply includes a rectification filter unit connected to the external power input source, a power factor correction unit connected to the rectification filter unit, a transformer, a pulse width control unit, a switch unit and a rectification output unit. More specifically, the power supply further includes a voltage stabilization power storage unit connected to the power factor correction unit to provide a stabilized voltage and a voltage detection unit connected to the voltage stabilization power storage unit to generate the power good signal through the stabilized voltage. The power supply can also include a signal isolation unit to bridge the voltage detection unit and power control unit. The signal isolation unit can be an optical coupler.

In another embodiment the power control unit includes a first output switch activated by the power good signal, and the backup control unit includes a second output switch activated by the conversion power and backup power.

In yet another embodiment the power regulation unit includes at least one DC/DC converter.

In yet another embodiment the power integration panel includes a charge control unit connected to the power storage unit and receiving the conversion power to control charging of the power storage unit. Moreover, the charge control unit can also be located in the power storage unit to connect to the power integration panel.

Through the aforesaid structures, compared with the conventions techniques, the invention provides many advantages, notably:

1. The problem of unable to supply normally the output power when regular supply of the external power input source is unavailable or the power supply malfunctions can be prevented. The invention, with the power control unit and backup control unit controlling output of the backup power from the power storage unit, the backup power can replace the conversion power to provide a buffer time for the motherboard to perform normal shutdown when the conversion power is abnormal, hence abnormal shutdown of the motherboard caused by abnormal conversion power can be avoided.

2. Operation interrupt problem taking place in the conventional redundant power supply system when the external power input source is unavailable is overcome. In the invention, the power storage unit outputs the backup power to provide a buffer time for normal output when the power supply cannot normally provide the conversion power.

3. The problem of erroneous judgments through a single voltage is avoided. The invention determines output of the conversion power through the power good signal and voltage comparison between the conversion power and backup power. Aside from determining output, the power good signal can also notify the motherboard about abnormal power supply in advance. Moreover, the backup power is output only when the voltage of the conversion power is lower than that of the backup power, hence the problems of erroneous judgments through a single voltage can be alleviated.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a first embodiment of the power supply system providing backup power of the invention.

FIG. 2 is a block diagram of a second embodiment of the power supply system providing backup power of the invention.

FIG. 3 is a block diagram of a third embodiment of the power supply system providing backup power of the invention.

FIG. 4 is a schematic view of the first embodiment of the power supply system providing backup power of the invention

### DETAILED DESCRIPTION OF THE PREFERRED EMBODIMENTS

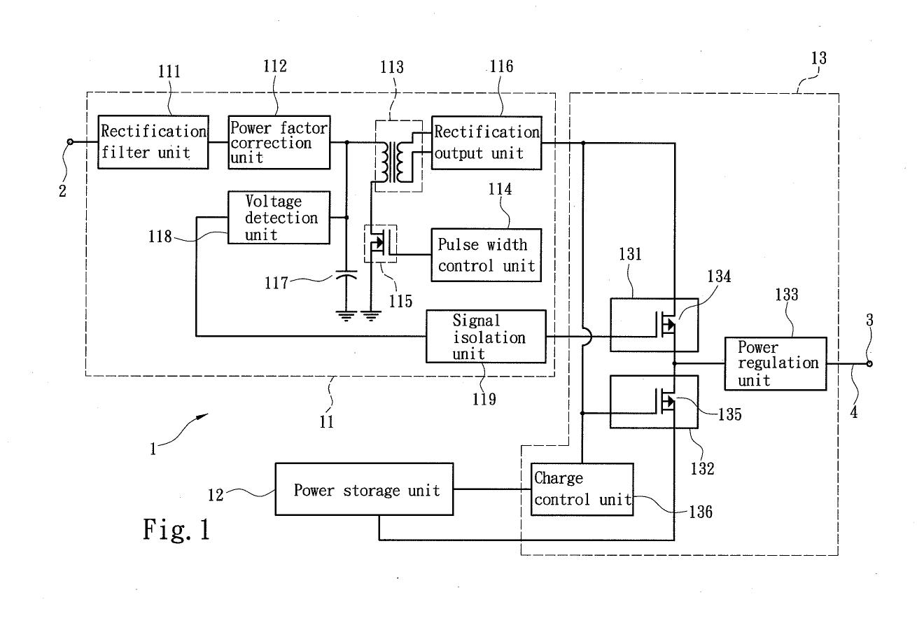

Please refer to FIG. 1, the invention aims to provide a power supply system 1 providing power that mainly includes at least one power supply 11, at least one power storage unit 12 and a power integration panel 13 connected to the power supply 11 and power storage unit 12. The power supply system 1 is connected to an external power input source 2 to receive an input power and convert the input power through the power supply 11 and power integration panel 13 to generate an output power sent to a power output terminal 4 to drive a motherboard 3. More specifically, the power supply 11 includes a rectification filter unit 111 connected to the external power input source 2, a power factor correction unit 112 connected to the rectification filter unit 111, a transformer 113, a pulse width control unit 114, a switch unit 115 and a rectification output unit 116. The external power input source 2 outputs an AC input power and the rectification filter unit 111 converts the AC input power into a DC power. Then the power factor correction unit 112 regulates the power factor and voltage of the input power through a transformation power level. The switch unit 115 has a duty cycle controlled by the pulse width control unit 114 to regulate the coil current passing through the transformer 113. Finally, the rectification filter unit 116 outputs a conversion power to the power integration panel 13. More specifically, the power supply 11 further includes a voltage stabilization power storage unit 117 connected to the power factor correction unit 112 and a voltage detection unit 118 connected to the voltage stabilization power storage unit 117. The voltage stabilization power storage unit 117 receives the input power whose power factor has been corrected and saves the input power, and also generates a stabilized voltage according to the input power. The voltage detection unit 118 detects the stabilized voltage via a set voltage in normal conditions. In the event that the stabilized voltage of the voltage stabilization power storage unit 117 is higher than the set voltage of the voltage detection unit 118, the voltage detection unit 118 generates a power good signal to indicate that the power supply 11 supplies power normally. The power supply 11 further sends the power good signal to the motherboard 3 for power management and control.

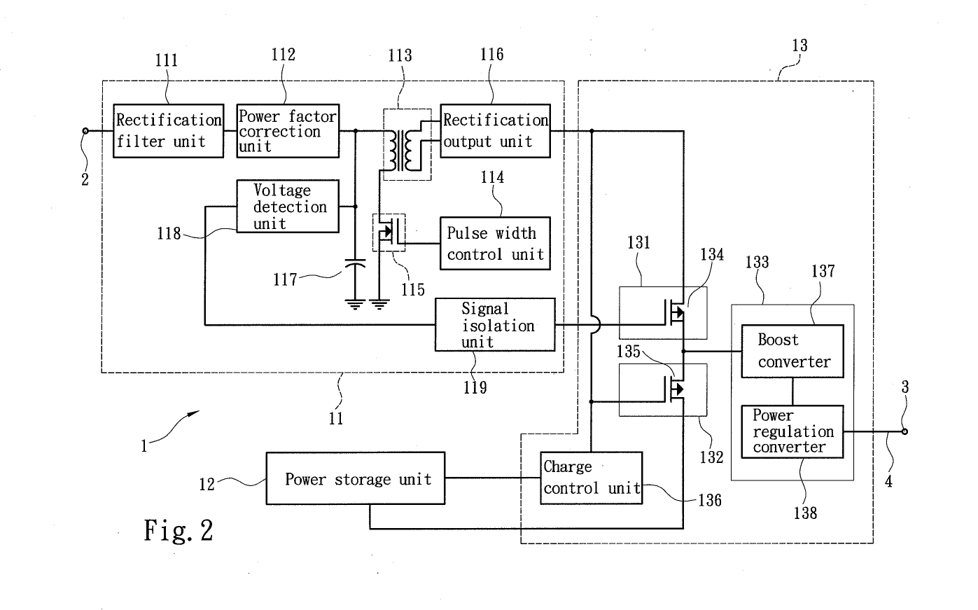

As previously discussed, the power storage unit 12 is connected to the power integration panel 13 and receives the conversion power therefrom for saving to provide a backup power. The power storage unit 12 can be a battery. The power integration panel 13 includes a power control unit 131, a backup control unit 132 and a power regulation unit 133. More specifically, the power control unit 131 can be a judgment unit to connect to the power supply 11 to get the power good signal. Through the power good signal, the conversion power can be determined to output or not. The backup control unit 132 can be a comparison unit connected to the power storage unit 12 to receive the backup power. Asides from receiving the backup power, the backup control unit 132 also can get the conversion power from the power integration panel 13 to normally compare the voltages between the conversion power and backup power to determine whether the backup power is output or not. The power regulation unit 133 is connected to the power control unit 131 and backup control unit 132 to receive the conversion power or backup power, and also regulate and convert the conversion power (or backup power) into the output power sent to the power output terminal 4. More specifically, the power control unit 131 further has a first output switch 134 which is set ON/OFF through the power good signal. The backup control unit 132 includes a second output switch 135 which is set ON/OFF according to the voltage of the conversion power and backup power. The first and second output switches 134 and 135 can be transistor elements or the like. Also referring to FIG. 2, the power integration panel 13 can further include a charge control unit 136 connected to the power storage unit 12 and receive the conversion power from the power integration panel 13 to control charging of the power storage unit 12. Furthermore, the power regulation unit 133 on the power integration panel 13 also includes at least one DC/DC converter. As depicted in the embodiment shown in FIG. 2, the power regulation unit 133 has a boost converter 137 and a power regulation converter 138. The boost converter 137 mainly boosts the voltage of the conversion power or backup power to a preset voltage, and then the power regulation converter 138 regulates and converts the boosted conversion power or backup power to become the output power sent to the motherboard 3.

Please refer to FIGS. 1 and 2 for implementation of the power supply system of the invention through an embodiment as an example. When the external power input source 2 normally supplies the input power and the power supply 11 also functions normally, the power supply 11 converts the input power into a conversion power and also generates the power good signal; meanwhile, the power control unit 131 receives the power good signal and determines to output the conversion power which is then regulated by the power regulation unit 133 to become the output power; finally, the output power is output via the power output terminal 4 to the motherboard 3. On the other hand, the power storage unit 12 receives the conversion power in the normal conditions from the power integration panel 13 and saves the conversion power to become the backup power. As the power supply 11 supplies the power normally, the voltage of the conversion power is higher than that of the backup power, hence the backup control unit 132 does not output the backup power. In the event that the external power input source 2 cannot provide the input power normally, or the power supply 11 malfunctions, the power supply 11 cannot generate the conversion power normally neither the power good signal, such that the power control unit 131 cannot receive the power good signal and is set off to stop outputting the conversion power. When the voltage of the conversion power drops gradually to lower than that of the backup power, the backup control unit 132 is activated to output the backup power. The backup power also is regulated by the power regulation unit 133 to become the output power, hence the motherboard 3 can still operate for a period of time without being shut down abnormally due to failure of the external power input source 2 or power supply 11. In the event that either the power supply 11 or power storage unit 12 malfunctions, the power supply 11 or power storage unit 12 can be replaced through hot plugging due to the power integration panel 13.

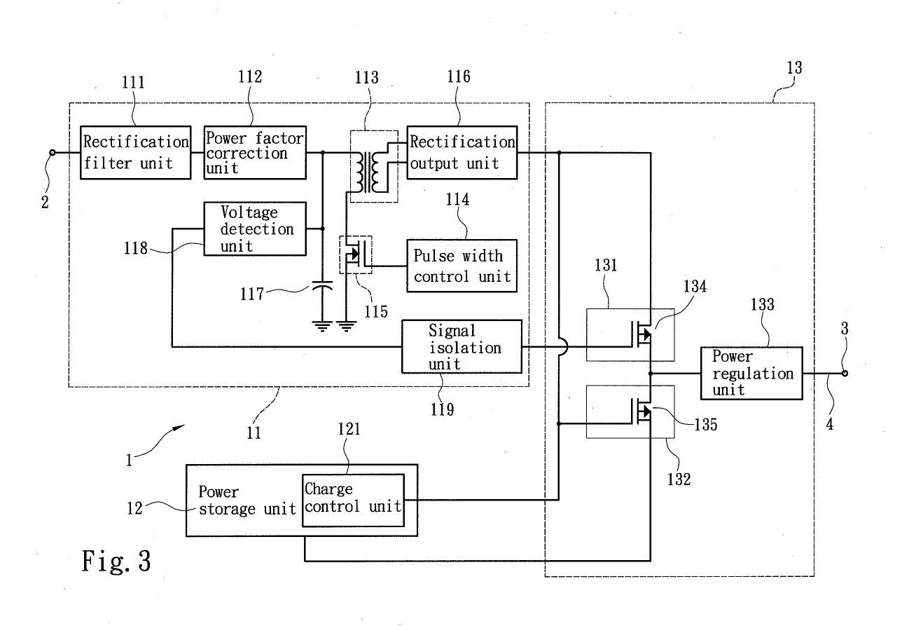

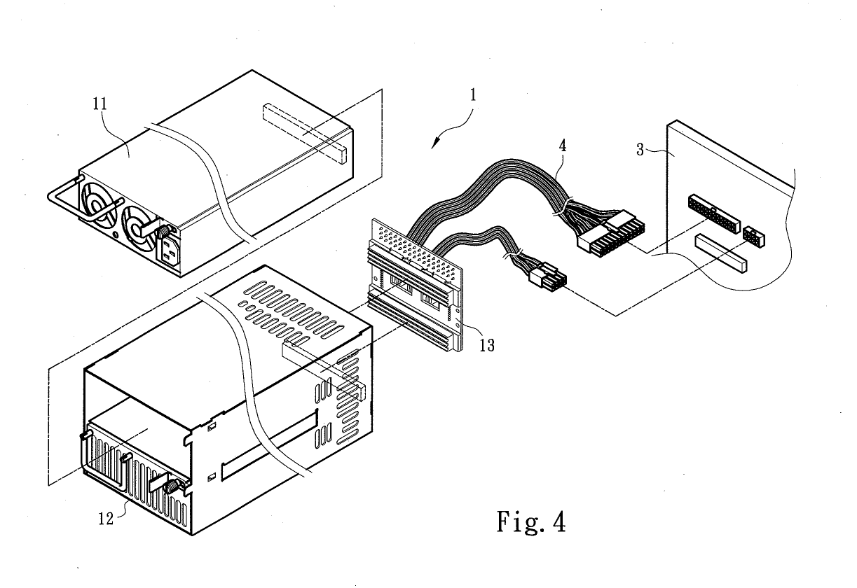

Also referring to FIG. 1, in order to avoid the power good signal from interfering by other electric signals, the power supply 11 of the invention can further include a signal isolation unit 119 to bridge the voltage detection unit 118 and power control unit 131. The signal isolation unit 119 can be an optical coupler. Please refer to FIGS. 2 and 3, in the embodiments previous discussed, the charge control unit 136 is located on the power integration panel 13, but this is not the limitation of the invention; it can also be located in the power storage unit 12 (shown by 121 in FIG. 3). The charge control unit 121 is connected to the power integration panel 13 to receive the conversion power and control charging of the power storage unit 12. The power supply system 1 also can be implemented as shown in FIG. 4, in which the power supply 11 and power storage unit 12 are made in the same specification and held in the power supply system 1. The power integration panel 13 also is located in the power supply system 1 with an electric connection cable to form the power output terminal 4 to send the output power to the motherboard 3.

As a conclusion, the invention provides a power supply system providing backup power. It includes at least one power supply, at least one power storage unit and a power integration panel. The power supply converts an input power into a conversion power and sends at the same time a power good signal to a motherboard. The power storage unit receives the conversion power in normal conditions and saves electric energy to generate a backup power. The power integration panel includes a power control unit which is connected to the power supply and determines whether the conversion power is output or not through the power good signal, a backup control unit which is connected to the power storage unit and compares the conversion power with the backup power to determine whether the backup power is output or not, and a power regulation unit connected to the power control unit and backup control unit to regulate the conversion power or backup power to become an output power. Thus the power supply system of the invention controls output of the conversion power and backup power through the power control unit and backup control unit, so that the problem of the conventional redundant power supply systems of instant shutdown caused by absence of the input power is overcome, and also the problem of erroneous judgments through a single voltage in the conventional techniques is resolved.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply system providing backup power being electrically connected to an external power input source to convert an input power into an output power and send the output power through an power output terminal to drive a motherboard, comprising:
at least one power supply connected to the external power input source to receive the input power and convert the input power into a conversion power, and send a power good signal at the same time to the motherboard;
at least one power storage unit to receive the conversion power in normal conditions and save electric energy to generate a backup power; and
a power integration panel including a power control unit which is connected to the power supply and determine whether the conversion power is output or not through the power good signal, a backup control unit which is connected to the power storage unit and compares the conversion power and the backup power to determine whether the backup power is output or not, and a power regulation unit which is connected to the power control unit and the backup control unit and regulates the conversion power or the backup power to be the output power sent to the power output terminal.

2. The power supply system of claim 1, wherein the power supply includes a rectification filter unit connected to the external power input source, a power factor correction unit connected to the rectification filter unit, a transformer, a pulse width control unit, a switch unit and a rectification output unit.

3. The power supply system of claim 2, wherein the power supply further includes a voltage stabilization power storage unit connected to the power factor correction unit to provide a stabilized voltage and a voltage detection unit connected to the voltage stabilization power storage unit to generate the power good signal through the stabilized voltage.

4. The power supply system of claim 3, wherein the power supply includes a signal isolation unit to bridge the voltage detection unit and the power control unit.

5. The power supply system of claim 4, wherein the signal isolation unit is an optical coupler.

6. The power supply system of claim 1, wherein the power control unit includes a first output switch activated by the power good signal, and the backup control unit includes a second output switch activated by the conversion power and the backup power.

7. The power supply system of claim 1, wherein the power regulation unit includes at least one DC/DC converter.

8. The power supply system of claim 1, wherein the power integration panel includes a charge control unit which is connected to the power storage unit and receives the conversion power to control charging of the power storage unit.

9. The power supply system of claim 1, wherein the power storage unit includes a charge control unit which is connected to the power integration panel and receives the conversion power to control charging of the power storage unit.
